(19) United States
(12) Patent Application Publication
(10) Pub. No.: US 2024/0086774 A1
(43) Pub. Date: Mar. 14, 2024

(54) TRAINING METHOD, TRAINING DEVICE, AND NON-TRANSITORY COMPUTER-READABLE RECORDING MEDIUM

(71) Applicant: Panasonic Intellectual Property Corporation of America, Torrance, CA (US)

(72) Inventors: Konstantinos Karras Kallidromitis, Mountain View, CA (US); Denis Gudovskiy, San Ramon, CA (US); Iku Ohama, Sunnyvale, CA (US); Kazuki Kozuka, Osaka (JP)

(21) Appl. No.: 18/504,300

(22) Filed: Nov. 8, 2023

Related U.S. Application Data
(63) Continuation of application No. PCT/JP2022/021262, filed on May 24, 2022.
(60) Provisional application No. 63/193,227, filed on May 26, 2021.

(51) Int. Cl. G06N 20/00

(52) U.S. Cl. CPC G06N 20/00

(57) ABSTRACT

A training method performed through batch learning by a computer includes: obtaining training data including first time-series data and second time-series data different from the first time-series data; performing first training processing of training a neural process (NP) model, which outputs, using a stochastic process, a prediction result that takes uncertainty into account, to predict first and second time-series data distributions, based on the first time-series data and second time-series data; and performing, using a contrastive learning algorithm, second training processing of (i) training the NP model to bring close to each other first sampling data items generated by sampling from the first time-series data distribution, (ii) training the NP model to bring close to each other second sampling data items generated by sampling from the second time-series data distribution, and (iii) training the NP model to push away the first and second sampling data items far from each other.

### CROSS REFERENCE TO RELATED APPLICATIONS

This is a continuation application of PCT International Application No. PCT/JP2022/021262 filed on May 24, 2022, designating the United States of America, which is based on and claims priority of U.S. Provisional Patent Application No. 63/193,227 filed on May 26, 2021. The entire disclosures of the above-identified applications, including the specifications, drawings and claims are incorporated herein by reference in their entirety.

### Field

The present disclosure relates to a training method, a training device, and a non-transitory computer-readable recording medium.

### Background

In artificial intelligence (AI) development, it is necessary to collect many labeled data items to acquire a high-accuracy model.

However, even when data items are successfully collected, the cost of labeling the data items is significant, which is a cause of hindering business applications of the data items.

Thus, there is a need to establish a training method that is capable of acquiring a high-accuracy model while reducing labeling, which is necessary for AI development.

For this need, for example, a technique capable of acquiring a high-accuracy model from image data items about 1% of which are labeled, by self-supervised learning using a data augmentation technique and contrastive learning is disclosed (e.g., Non Patent Literature (NPL) 1). Specifically, in NPL 1, two versions of image data in a pair are generated by performing data augmentation on input image data items. Then, contrastive learning to maximize feature quantities of the same image data items (bring the feature quantities close to each other) and minimize feature quantities of different data items (push the feature quantities away far from each other) is performed. In this manner, by using the data augmentation and the contrastive learning, a model can be trained to be a high-accuracy model from a small amount of data and a small number of labels.

### CITATION LIST

### Non Patent Literature

NPL 1: J. Gordon, W. P. Bruinsma, A. Y. K. Foong, J. Requeima, Y. Dubois, and R. E. Turner. Convolutional conditional neural processes. In International Conference on Learning Representations (ICLR), 2020.

NPL 2: T. Chen, S. Kornblith, M. Norouzi, and G. Hinton. A simple framework for contrastive learning of visual representations. arXiv: 2002.05709, 2020.

### SUMMARY

### Technical Problem

However, the technique disclosed in NPL 1 described above is a method effective in handling image data but cannot handle time-series data.

The present disclosure is made in view of the above-described circumstances, and an object of the present disclosure is to provide a training method and the like capable of handling time-series data in self-supervised learning.

### Solution to Problem

A training method according to an aspect of the present disclosure is a training method performed through batch learning by a computer, and includes: obtaining training data including first time-series data and second time-series data different from the first time-series data; performing first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account; and performing, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

These general and specific aspects may be implemented using a system, a device, a method, an integrated circuit, a computer program, or a computer-readable recording medium such as a CD-ROM, or any combination of systems, devices, methods, integrated circuits, computer programs, or recording media.

### Advantages Effects

According to the present disclosure, a training method and the like capable of handling time-series data in self-supervised learning can be implemented.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of a configuration of a training device according to an embodiment.

FIG. 2 is a diagram schematically illustrating processing performed by the training device according to the embodiment.

FIG. 3 is a diagram schematically illustrating processing performed by the training device according to the embodiment.

FIG. 4A is a diagram for schematically describing contrastive self-supervised learning.

FIG. 4B is a diagram for schematically describing an example of generating a boundary by performing the contrastive self-supervised learning illustrated in FIG. 4A.

FIG. 5A is a diagram for schematically describing a prediction distribution by a neural process.

FIG. 5B is a diagram illustrating an example of a prediction result by a neural process illustrated in FIG. 5A.

FIG. 6 is a diagram for schematically describing first training processing and second training processing according to the embodiment.

FIG. 7 is a diagram illustrating a pseudocode of an algorithm which is a processing procedure for the training device according to the embodiment.

FIG. 8 is a flowchart illustrating an outline of operation of the training device according to the embodiment.

FIG. 9 is a diagram showing results of evaluating performance of a model according to the present disclosure using datasets according to an experimental example.

FIG. 10 is a graph illustrating accuracies when ContrNP (ours) was trained with different label percentages of the AFDB dataset according to the experimental example.

### DESCRIPTION OF EMBODIMENT

A training method according to an aspect of the present disclosure is a training method performed through batch learning by a computer, and includes: obtaining training data including first time-series data and second time-series data different from the first time-series data; performing first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account; and performing, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

Accordingly, a training method and the like capable of handling time-series data in self-supervised learning can be implemented by combining a framework of contrastive self-supervised learning and a framework of training a neural process model.

Here, for example, the first time-series data may be time-series sampling data obtained by sampling temporally-continuous first data, and the second time-series data may be time-series sampling data obtained by sampling temporally-continuous second data.

Also, for example, the first training processing and the second training processing may be performed concurrently, and the performing of the first training processing and the second training processing may include using an error function in which a second error function is changed by adding a term of a first error function used in the contrastive learning algorithm to a term of the second error function, the first error function reducing an error in a case of the positive samples and increasing the error in a case of the negative samples, the second error function pertaining to an error of a prediction result used by the neural process model.

In this manner, the first training processing and the second training processing are performed using an error function that is a combination of the first error function used in the contrastive learning algorithm and the second error function pertaining to the error of the prediction result used by the neural process model. With this, it is possible to concurrently perform, on a neural process model which is a training target, the first training processing of causing the neural process model to learn the prediction distributions by a neural process and the second training processing of causing the neural process model to perform feature representation learning using contrastive self-supervised learning.

A training device according to an aspect of the present disclosure is a training device that performs training through batch learning, and includes: an obtainer that obtains training data including first time-series data and second time-series data different from the first time-series data; and a training processor that performs first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account, and performs, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

Further, a non-transitory computer-readable recording medium according to an aspect of the present disclosure is a non-transitory computer-readable recording medium having recorded thereon a program for causing a computer to execute a training method through batch learning, the program causing the computer to execute: obtaining training data including first time-series data and second time-series data different from the first time-series data; performing first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account; and performing, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

Note that these general or specific aspects may be implemented using a system, a device, a method, an integrated circuit, a computer program, or a computer-readable recording medium such as a CD-ROM, or any combination of systems, devices, methods, integrated circuits, computer programs, or recording media.

Hereinafter, an exemplary embodiment of the present disclosure will be described with reference to the accompanying Drawings. The exemplary embodiment described below shows one specific example of the present disclosure. The numerical values, shapes, constituent elements, steps, the processing order of the steps etc. shown in the following exemplary embodiment are mere examples, and therefore do not limit the scope of the present disclosure. Also, among the constituent elements in the following exemplary embodiment, those not recited in any one of the independent claims are described as optional elements. Also, in all the embodiments, the details of each embodiment can be combined.

### EMBODIMENT

Hereinafter, a training method and the like according to the present embodiment will be described with reference to the accompanying Drawings.

### [1 Training Device 1]

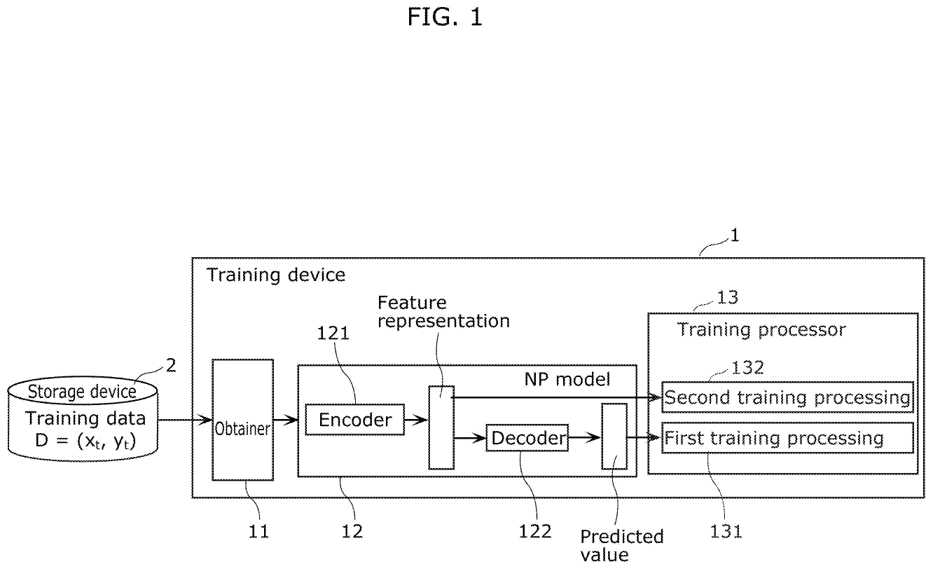

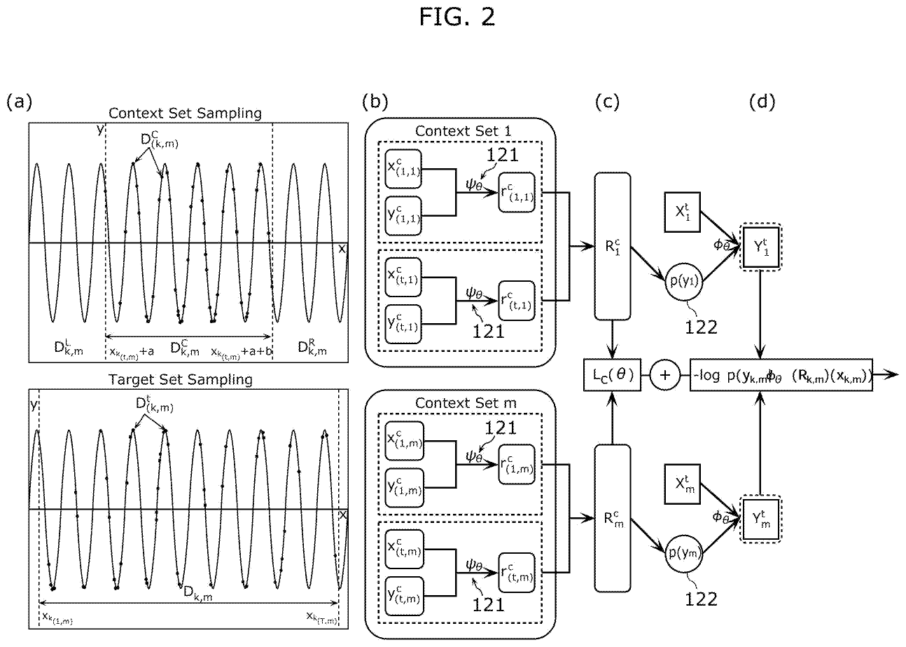

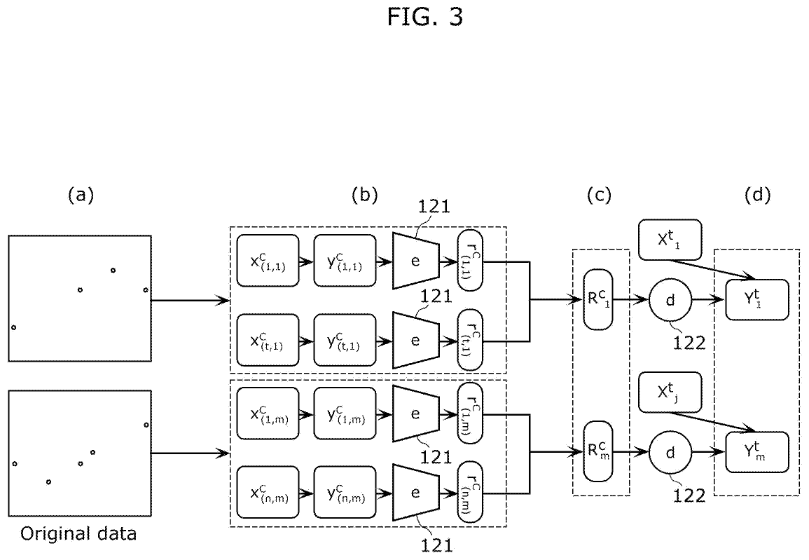

FIG. 1 is a block diagram illustrating an example of a configuration of training device 1 according to the present embodiment. FIG. 2 and FIG. 3 are diagrams each schematically illustrating processing performed by training device 1 according to the present embodiment. FIG. 3 represents the processing illustrated in FIG. 2 in another presentation.

Training device 1 is a device for learning time-series representations as feature representations, using self-supervised learning that uses a combination of contrastive learning and a neural process model.

In the present embodiment, as illustrated in FIG. 1, training device 1 includes obtainer 11, NP model 12, and training processor 13.

### [1.1 Obtainer 11]

Obtaine 11 includes, for example, a computer that includes memory and a processor (microprocessor), and implements various functions as a result of the processor executing a control program stored in the memory. Specifically, obtainer 11 obtains training data including first time-series data and second time-series data different from the first time-series data. Here, for example, the first time-series data is time-series sampling data obtained by sampling temporally-continuous first data, and the second time-series data is time-series sampling data obtained by sampling temporally-continuous second data.

In the present embodiment, obtainer 11 obtains, for example, time-series data items (xₜ, yₜ) included in training data D stored in storage device 2 that is outside training device 1, as illustrated in FIG. 1. The time-series data items are discrete, temporally-continuous data items (sampling data items) obtained by sampling continuous, temporally-continuous data. Here, xₜ indicates time information (timestamp) of a certain time point t, and yₜ indicates an output corresponding to xₜ.

The present embodiment is described on the assumption that the training data including the time-series data items as the sampling data items is stored in storage device 2. However, this is not limiting. Continuous, temporally-continuous data may be stored in storage device 2. In this case, obtainer 11 is to obtain, as the training data, time-series data items (xₜ, yₜ) as sampling data items obtained by sampling continuous, temporally-continuous data. Storage device 2 is a recording medium capable of storing data. Storage device 2 is constituted by, for example, rewritable, nonvolatile memory such as a hard disk drive and a solid state drive.

For example, the upper and lower rows in (a) of FIG. 2 schematically illustrate processing of obtaining sets of time-series data as sets of sampling data, from time-series analog data being continuous, temporally-continuous data. In (a) of FIG. 2, time-series analog data D, which is observed time-series data, is divided into {D₁, D₂, . . . , Dₖ, D_{K}}, that is, K segments. (a) of FIG. 2 schematically illustrates that time-series analog data in a segment Dₖ among the K segments divided into are sampled, by which D^{c}_{k,m} and D^{t}_{k,m} are obtained as the training data. That is, (a) of FIG. 2 illustrates processing in which obtainer 11 obtains D^{c}_{k,m}, which is context set sampling data, and D^{t}_{k,m}, which is target set sampling data, as the time-series data.

In other words, D^{c}_{k,m} being the context set sampling data is obtained by sampling the time-series analog data within a limited range in segment Dₖ rather than the entire range of segment Dₖ. In the example illustrated in (a) of FIG. 2, the range of segment Dₖ is divided into three ranges D^{L}_{k,m}, D^{C}_{k,m}, and D^{R}_{k,m}. Here, D^{L}_{k,m}, D^{C}_{k,m}, and D^{R}_{k,m} can be given as D^{L}_{k,m}={{x_{i′}, y_{i′}}∈D_{k,m}|x_{i′}≤a}, D^{C}_{k,m}={{x_{i′}, y_{i′}}∈D_{k,m}|a<x_{i′}<b}, and D^{R}_{k,m}={{x_{i′}, y_{i′}}∈D_{k,m}|b≤x_{i′}}. a and b are threshold values. (a) of FIG. 2 illustrates that D^{C}_{k,m} being the context set sampling data is obtained by sampling the time-series analog data within the range D^{C}_{k,m} divided into. D^{t}_{k,m} being the target set sampling data is obtained by sampling the time-series analog data within the entire range of segment Dₖ.

In (a) of FIG. 2, D^{C}_{k,m} being the context set sampling data is used by encoder 121 of NP model 12 described later to generate the feature representations. D^{t}_{k,m} being the target set sampling data is used to examine a predicted value output by decoder 122 of NP model 12 described later.

For example, the upper and lower rows in (a) of FIG. 3 schematically illustrate an example of sets of time-series data as the sets of sampling data, as sets of original data. The original data illustrated in the upper row in (a) of FIG. 3 is, for example, an example of first time-series data, and the original data illustrated in the lower row in (a) of FIG. 3 is, for example, an example of second time-series data.

### [1.2 NP Model 12]

NP model 12 trained by training device 1 is a neural process model that is a deep learning model that outputs, using a stochastic process, a prediction result that takes uncertainty into account. In the present embodiment, NP model 12 is, for example, a neural process model using a structure described in Convolutional Conditional Neural Processes (ConvCNP) disclosed in NPL 2. Note that Neural Processes (NP) is a deep learning model that is capable of predicting an output value for a new input conditioned by observation data. In other words, Neural Processes (NP) is a deep learning model that is capable of predicting a distribution of a function conditioned by observation data.

For NP model 12, learning a prediction distribution based on a neural process and feature representation learning using contrastive self-supervised learning are performed by training processor 13 described later. After the learning, NP model 12 is capable of generating a plurality of predicted values from the same data point in the time-series data.

In the present embodiment, as illustrated in FIG. 1, NP model 12 includes encoder 121 and decoder 122.

### [1.2.1 Encoder 121]

Encoder 121 is used to extract, from time-series data input into obtainer 11, time-series representations as feature representations in a latent space. Encoder 121 is a neural network that includes at least a convolution neural networks (CNN) layer.

The upper rows in (b) and (c) of FIG. 2 illustrate an example of processing in which encoder 121 extracts feature representations r^{c}_{(1,1)} and r^{c}_{(t,1)} in the latent space from two random sample points (x^{c}_{(1,1)}, y^{c}_{(1,1)}) and (x^{c}_{(t,1)}, y^{c}_{(t,1)}) in D^{c}_{k,m}, being the context set sampling data. Note that ψ_{θ} indicated in (b) of FIG. 2 represents encoder 121 with model parameter θ. Feature representations r^{c}_{(1,1)} and r^{c}_{(t,1)} in the latent space that are extracted by encoder 121 are, as shown in the upper row in (c) of FIG. 2, aggregated into a feature representation R^{c}₁ in the latent space. Feature representation R^{c}₁ in the latent space is a feature representation in a latent space of function fₖ capable of representing an input-output relationship between two sample points (x^{c}_{(1,1)}, y^{c}_{(1,1)}) and (x^{c}_{(t,1)}, y^{c}_{(t,1)}).

Likewise, the lower rows in (b) and (c) of FIG. 2 illustrate an example of processing in which encoder 121 extracts feature representations r^{c}_{(1,m)} and r^{c}_{(t,m)} in the latent space from two random sample points (x^{c}_{(1, m)}, y^{c}_{(1, m)}) and (x^{c}_{(t, m)}, y^{c}_{(t, m)}) in D^{c}_{k,m} being the context set sampling data. Feature representations r^{c}_{(1,m)} and r^{c}_{(t,m)} in the latent space that are extracted by encoder 121 are, as shown in the upper row in (c) of FIG. 2, aggregated into a feature representation R^{c}ₘ in the latent space. Feature representation R^{c}_{(t,m)} in the latent space is a feature representation in a latent space of) function fₖ capable of representing an input-output relationship between two sample points (x^{c}_{(1,m)}, y^{c}_{(1,m)}) and (x^{c}_{(t,m)}, y^{c}_{(t,m)}).

Note that a description of the upper and lower rows in (b) and (c) of FIG. 3 will be omitted because the upper and lower rows illustrate processing that is the same as the processing illustrated in the upper and lower rows in (b) and (c) of FIG. 2. In addition, (b) and (c) of FIG. 2 have no illustration of processing on D^{t}_{k,m} being the target set sampling data. A description of the processing will be omitted because the processing is the same as the processing on D^{c}_{k,m} being the context set sampling data.

### [1.2.2 Decoder 122]

Decoder 122 outputs predicted values from feature representations in the latent space that are extracted and aggregated into by encoder 121. More specifically, decoder 122 predicts a time-series data distribution that indicates a statistical characteristic of time-series data input into encoder 121, from feature representations in the latent space that are extracted and aggregated into by encoder 121, such as embedding vectors. Decoder 122 is constituted by a neural network of a type different from that of encoder 121.

In an example illustrated in the upper row in (d) of FIG. 2, decoder 122 outputs a mean and a standard deviation of predicted values Y^{t}₁, that is, a distribution Y^{t}₁ predicted from inputs X^{t}₁ that are obtained from D^{c}_{k,m} being the context set sampling data and from feature representations R^{t}₁ pertaining to inputs X^{t}₁ in the latent space. Likewise, in an example illustrated in the lower row in (d) of FIG. 2, decoder 122 outputs a mean and a standard deviation of predicted values Y^{t}ₘ, that is, a distribution Y^{t}ₘ predicted from inputs X^{t}ₘ that are obtained from Dₜ^{k,m} being the target set sampling data and from feature representations R^{t}ₘ pertaining to inputs X^{t}ₘ in the latent space.

Note that a description of the upper and lower rows in (d) of FIG. 3 will be omitted because the upper and lower rows illustrate processing that is the same as the processing illustrated in the upper and lower rows in (d) of FIG. 2.

### [1.3 Training Processor 13]

Training Processor 13 includes a computer including, for example, memory and a processor (microprocessor), and implements a function of performing training processing as a result of the processor executing a control program stored in the memory. Training Processor performs, on NP model 12, first training processing 131 of causing NP model 12 to learn the prediction distributions by a neural process and second training processing 132 of causing NP model 12 to perform feature representation learning using contrastive self-supervised learning.

Here, feature representation learning using contrastive self-supervised learning and a prediction distribution by a neural process will be outlined.

### [1.3.1 Contrastive Self-Supervised Learning]

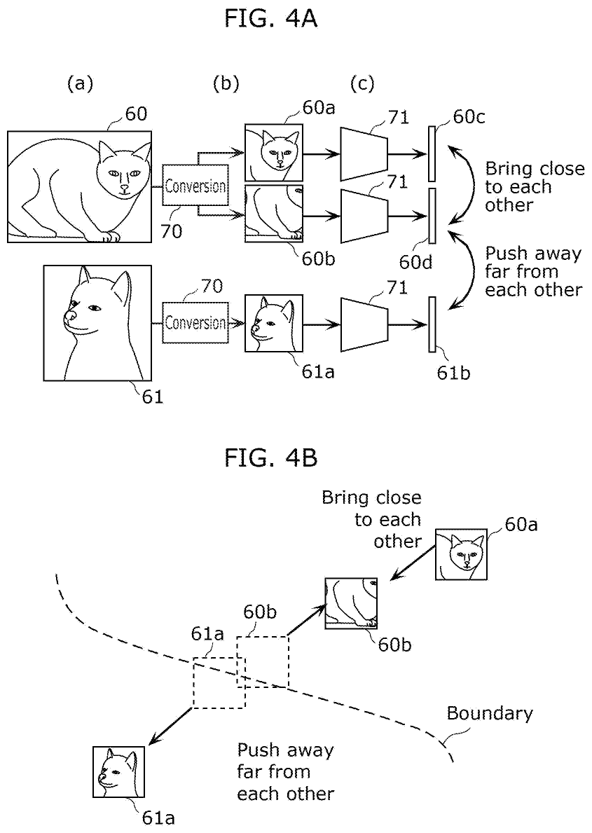

FIG. 4A is a diagram for schematically describing contrastive self-supervised learning. FIG. 4B is a diagram for schematically describing an example of generating a boundary by performing the contrastive self-supervised learning illustrated in FIG. 4A. (a) of FIG. 4A illustrates cat image 60 and dog image 61 that are labeled. The upper row in (b) of FIG. 4A illustrates image 60a and image 60b converted that are obtained by subjecting cat image 60 to conversion processing by conversion 70. The lower row in (b) of FIG. 4A illustrates image 61a converted that are obtained by subjecting dog image 61 to the conversion processing by conversion 70. In conversion 70, data augmentation processing is performed as the conversion process. In the example illustrated in FIG. 4A, the case where trimming processing is performed is illustrated. Image 60a and image 60b therefore correspond to parts of cat image 60, including parts of the cat. Likewise, image 61a corresponds to a part of dog image 61, including a part of the dog.

The upper and lower rows in (c) of FIG. 4A schematically illustrates that the contrastive self-supervised learning is performed using image 60a, image 60b, and image 61a converted.

Here, the contrastive learning is an approach in which learning is performed in such a manner that embedding vectors for images originating from the same image are brought close to each other in an embedding space and that embedding vectors for images originating from different images are pushed away far from each other.

The contrastive self-supervised learning is a type of self-supervised learning. The contrastive self-supervised learning is learning that uses labeled data to promote bringing embedding vectors of data items obtained from data items labeled as the same class close to each other and to promote pushing embedding vectors of data items obtained from data items labeled as different classes away far from each other.

More specifically, in the example illustrated in FIG. 4A, image 60a and image 60b are trimmed images that are labeled as the same class, that is, of cat image 60. Therefore, encoder 71 illustrated in the upper row in (c) of FIG. 4A is trained to bring embedding vector 60c, which is a feature representation of image 60a extracted by encoder 71, and embedding vector 60d, which is a feature representation of image 60b extracted by encoder 71, close to each other. In contrast, image 60b and image 61a are trimmed images labeled as different classes, that is, of cat image 60 and dog image 61. Therefore, encoder 71 illustrated in (c) of FIG. 4A is trained to push embedding vector 60d, which is a feature representation of image 60b extracted by encoder 71, and embedding vector 61b, which is a feature representation of image 61a extracted by encoder 71, away far from each other.

Performing the contrastive self-supervised learning illustrated in FIG. 4A schematically corresponds to learning of pushing image 61a and image 60b away far from each other and bringing image 60b and image 60a close to each other as illustrated in FIG. 4B and corresponds to making it easy to draw a boundary to distinguish between a dog and a cat.

By performing the contrastive self-supervised learning in this manner, a model capable of performing recognition sensitive to difference in appearance can be generated from a few image data items. In other words, performing the contrastive self-supervised learning enables the model to learn consistency of the data. Thus, a high-accuracy model having a high recognition performance can be acquired even from a few labeled data items.

### [1.3.2 Prediction Distribution by Neural Process]

Subsequently, a prediction distribution by a neural process will be described.

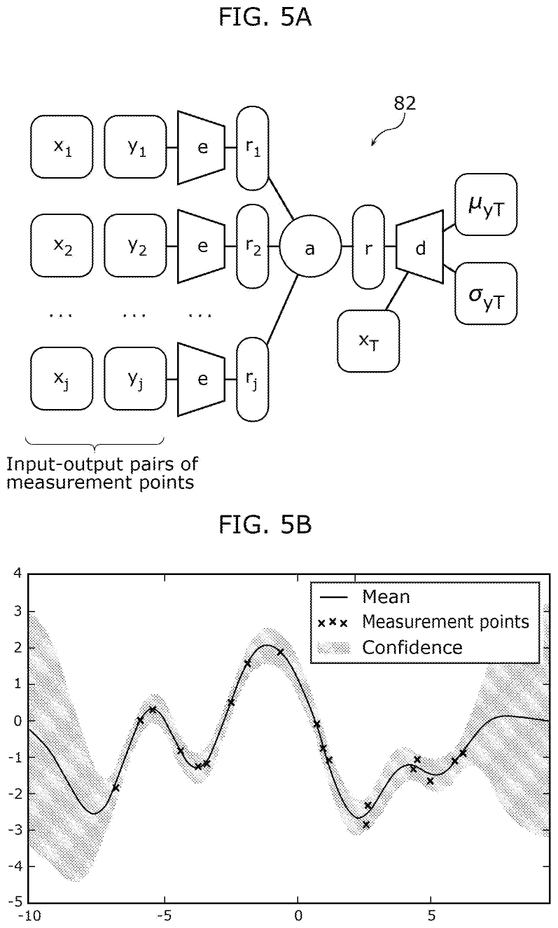

FIG. 5A is a diagram for schematically describing a prediction distribution by a neural process. FIG. 5A illustrates a structure of a neural process model and an example of processing by the neural process model. FIG. 5B is a diagram illustrating an example of a prediction result by a neural process illustrated in FIG. 5A.

As illustrated in FIG. 5A, a structure of neural process model 82 is constituted by two types of neural networks, encoder e and decoder d, as with a variational autoencoder. With this configuration, neural process model 82 is a deep learning model capable of performing regression on time-series data, taking uncertainty into account, as a Gaussian process, which is a machine learning approach other than the deep learning.

In neural process model 82, as illustrated in FIG. 5A, j input-output pairs of measurement points {(x₁, y₁), (xⱼ)} are input into encoder e. The measurement points (xⱼ, yⱼ) may be different data points in time-series data. In neural process model 82, outputs rⱼ from encoder e for the measurement points (xⱼ, yⱼ) are calculated, and then aggregator a is caused to aggregate outputs rⱼ calculated and to calculate r, which is a latent representation vector for the plurality of measurement points. In the example illustrated in FIG. 5A, aggregator a is caused to calculate mean r of outputs rⱼ as the latent representation vector of the plurality of measurement points. Then, by inputting, into decoder d, mean r being the latent representation vector of the plurality of measurement points together with predicted points x_{T}, neural process model 82 is enabled to predict output y_{T} that takes the measurement points into account. Note that the prediction of output y_{T} is made by outputting mean μ_{yT} and standard deviation σ_{yT} of a distribution (regression) that are predicted from the plurality of measurement points.

In FIG. 5B, a distribution (regression) predicted from a plurality of measurement points indicated with “x” is illustrated with a region named Confidence, as a prediction result by neural process model 82 illustrated in FIG. 5A. The solid line illustrated in FIG. 5B indicates a mean of the distribution (regression) predicted from the plurality of measurement points indicated with “x.” The region Confidence indicates uncertainty of the distribution (regression) predicted from the plurality of measurement points. The distribution (regression) predicted from the plurality of measurement points is considered to be indicative of a statistical characteristic of the plurality of measurement points.

Use of such neural process model 82 makes it possible to output, using a stochastic process, a prediction result that takes uncertainty into account.

### [1.3.3 Details of First Training Processing 131 and Second Training Processing 132]

Training Processor 13 performs, on NP model 12, first training processing 131 of causing NP model 12 to learn prediction distributions by a neural process and second training processing 132 of causing NP model 12 to perform feature representation learning using contrastive supervised learning.

More specifically, training processor 13 performs, on NP model 12, first training processing 131 of training NP model 12 to predict, based on the first time-series data and the second time-series data, a first time-series data distribution indicating a statistical characteristic of the first time-series data and a second time-series data distribution indicating a statistical characteristic of the second time-series data. Further, training processor 13 performs second training processing 132 of causing NP model 12 to perform feature representation learning using a contrastive learning algorithm. Specifically, as second training processing 132, training processor 13 trains NP model 12 to bring first sampling data items close to each other as positive samples. Here, the first sampling data items are data items generated by sampling from the first time-series data distribution. Also, as second training processing 132, training processor 13 trains NP model 12 to bring second sampling data items close to each other as positive samples. Here, the second sampling data items are data items generated by sampling from the second time-series data distribution. On the other hand, as second training processing 132, training processor 13 trains NP model 12 to push away the first sampling data items and the second sampling data items far from each other as negative samples. In the present embodiment, training processor 13 performs first training processing 131 and second training processing 132 through batch learning. Note that training processor 13 may perform the first training processing and the second training processing concurrently.

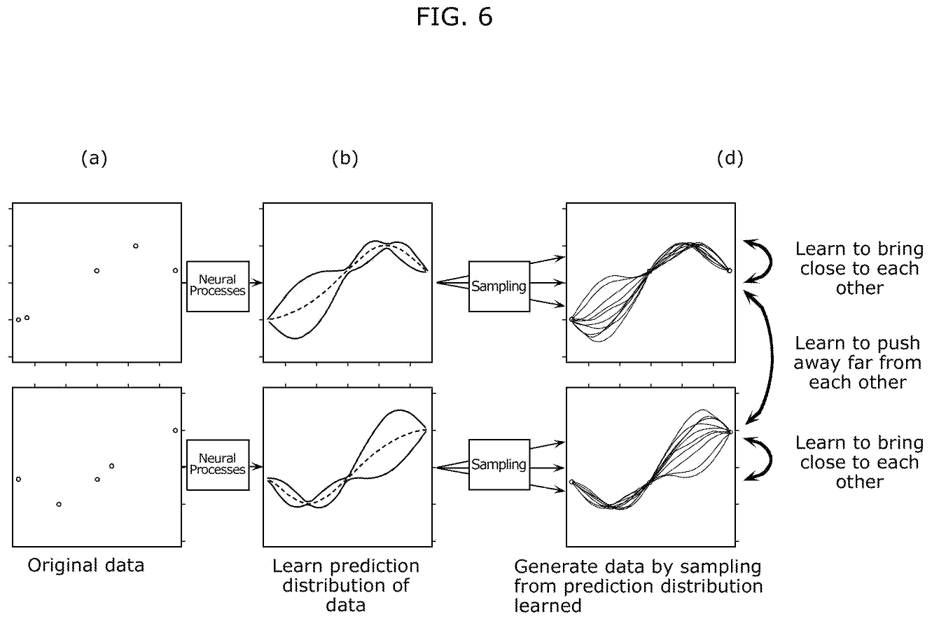

Here, with reference to FIG. 6, a training method according to the present disclosure, that is, first training processing 131 and second training processing 132 according to the present embodiment will be schematically described.

FIG. 6 is a diagram for schematically describing first training processing 131 and second training processing 132 according to the present embodiment.

The upper and lower rows in (a) of FIG. 6 illustrate two different sets of original data. The sets of original data illustrated in the upper and lower rows in (a) of FIG. 6 correspond to the sets of original data illustrated in (a) of FIG. 3. That is to say, the original data illustrated in the upper row in (a) of FIG. 6 is, for example, an example of first time-series data, and the original data illustrated in the lower row in (a) of FIG. 6 is, for example, an example of second time-series data.

The upper and lower rows in (b) of FIG. 6 schematically illustrate distributions showing statistical characteristics of the sets of original data predicted from the sets of original data by performing the first training processing on NP model 12 (prediction distributions of the data). The dotted lines illustrated in the prediction distributions in (b) of FIG. 6 are, for example, means of the prediction distributions. Therefore, in the first training processing for NP model 12, parameters and the like of NP model 12 are learned so that NP model 12 can output the distributions showing the predicted statistical characteristics of the sets of original data (the prediction distributions of the data) from the sets of original data.

The upper and lower rows in (d) of FIG. 6 schematically illustrate that contrastive self-supervised learning is performed using sets of data generated by sampling the prediction distributions learned by the first training processing. That is, in the present embodiment, the prediction distributions of the sets of time-series data are predicted using NP model 12 that has been trained by the first training processing, instead of conventional data augmentation processing such as trimming. Then, the sets of data generated by sampling the regions indicating the prediction distributions predicted are used in the contrastive self-supervised learning. Accordingly, time-series data can be handled in contrastive self-supervised learning.

More specifically, a set of data items that are generated by sampling the prediction distribution predicted by the neural process from the original data illustrated in the upper row in (a) of FIG. 6 originate from the same data. Therefore, the second training processing, in which contrastive learning is performed in such a manner as to bring embedding vectors of the data items close to each other, is performed. Likewise, a set of data items that are generated by sampling the prediction distribution predicted by the neural process from the original data illustrated in the lower row in (a) of FIG. 6 originate from the same data. Therefore, the second training processing, in which contrastive learning is performed in such a manner as to bring embedding vectors of the data items close to each other, is performed.

In contrast, the set of data items that are generated by sampling the prediction distribution predicted by the neural process from the set of original data illustrated in the upper row in (a) of FIG. 6 and the set of data items that are generated by sampling the prediction distribution predicted by the neural process from the set of original data illustrated in the lower row in (a) of FIG. 6 originate from different data. Therefore, the second training processing in which contrastive learning is performed in such a manner as to push embedding vectors of the sets of data items that are generated by sampling the prediction distributions predicted by the neural process from the sets of original data illustrated in the upper and lower rows in (a) of FIG. 6 away far from each other is performed.

In the example illustrated in FIG. 2 and FIG. 3, feature representations R^{c}ₘ and R^{c}₁ in the latent spaces illustrated in (c) of FIG. 2 and FIG. 3 correspond to the embedding vectors of the data items that are generated by sampling the prediction distributions predicted by the neural process illustrated in (c) of FIG. 6. In addition, predicted values Y^{t}₁ and Y^{t}ₘ illustrated in (d) of FIG. 2 and FIG. 3, that is, (means and standard deviations of) distributions Y^{t}₁ and Y^{t}ₘ correspond to (means and standard deviations of) the prediction distributions of the data.

As illustrated in (c) of FIG. 2, feature representations R^{c}ₘ and R^{c}₁ in the latent space are learned using a first error function for contrastive learning indicated with Lc(θ). That is, in the second training processing, the first error function is used to train NP model 12 in such a manner as to bring data items in feature representations R^{c}ₘ and R^{c}₁ in the latent space extracted by encoder 121 close to each other when the data items originate from the same data and to push data items in feature representations R^{c}ₘ and R^{c}₁ in the latent space extracted by encoder 121 away far from each other when the data items originate from different data.

Distributions Y^{t}₁ and Y^{t}ₘ illustrated in (d) of FIG. 2 are learned using a log-likelihood function given by −og p(Y_{k,m} |ψ_{θ}(R_{k,m})(X_{k,m})) that is used in learning in the neural process, as a second error function. That is, in the first training processing, outputs of decoder 122 are compared with theoretical values of distributions Y^{t}₁ and Y^{t}ₘ using the second error function, and NP model 12 is trained so that encoder 121 extracts feature representations R^{c}ₘ and R^{c}₁ in the latent space with smaller errors.

More specifically, when performing the first training processing and the second training processing, an error function in which a second error function is changed by adding a term of a first error function used in the contrastive learning algorithm to a term of the second error function is used. The first error function is an error function that reduces an error in a case of the positive samples and increasing the error in a case of the negative samples. The first error function is also called a contrastive error function. The second error function is an error function pertaining to an error of a prediction result used by the neural process model. In such a manner, training processor 13 performs the first training processing and the second training processing using a final error function that is a combination of the first error function and the second error function.

Lc(θ) indicated in (c) of FIG. 2, that is, the first error function can be given by Equation 1.

$$\begin{matrix}[ Math . 1 ] & \\ {L}_{C} ( θ , {O}_{1 : K} ) = {\sum }_{k = 1}^{K} {\sum }_{i = 0}^{n - 1} [ log \frac{exp ( sim ( {φ}_{θ} ( {O}_{( k , j )} ) , {ψ}_{θ} ( {O}_{( k , l )} )}{{\sum }_{i = 1}^{K} exp ( sim ( {φ}_{θ} ( {O}_{( k , j )} ) , {ψ}_{θ} ( {O}_{( k , l )} )} ] & ( Equation 1 )\end{matrix}$$

Here, O(k,n) indicates sampling data generated by sampling the time-series data distribution.

Ψ_{θ}(O_{(k,j)}) [Math. 2]

is vector representation R_{(k,j)} of data as an anchor extracted by encoder 121.

Ψ_{θ}(O_{(k,l)}) [Math. 3]

is vector representation R_{(k,i)} of data as a positive sample extracted by encoder 121.

In addition,

Ψ_{θ}(O_{(k,l)}) [Math. 4]

is vector representation R_{(k,l)} of data as a negative sample extracted by encoder 121.

In Equation 1, sim denotes a cosine similarity, which is typically written as

sim(u,v)=u^{T}v/∥u∥ ∥v∥ [Math. 5]

Note that Equation 1 means an error function that is an error function termed normalized Temperature CrossEntropy (NT-Xent), which is used in SimCLR, applied to data generated by sampling instead of data generated by data augmentation.

Then, a final error function that is a combination of the first error function and the second error function and is to be used by training processor 13 can be given by Equation 2 shown below.

$$\begin{matrix}[ Math . 6 ] & \\ L ( θ ) = - {\sum }_{k = 1}^{K} {\sum }_{( x , y ) ∈ {t}_{k}} log p ( {y}^{T} \vert {ϕ}_{θ} ( {R}_{k}^{C} ) ( {x}^{T} ) ) + {h \times {L}_{C} ( θ , {O}_{1 : K} )}_{Contrastive Term} & ( Equation 2 )\end{matrix}$$

As shown in Equation 2, the final error function which is the combination of the first error function and the second error function and is to be used by training processor 13 is an error function obtained by adding a term that is the first error function multiplied by hyperparameter h to the second error function. In the error function shown in Equation 2, its first term can be referred to as a regression term, and its second term can be referred to as a contrastive term. Using the error function shown in Equation 2, training processor 13 can concurrently perform first training processing 131 of causing NP model 12 to learn the prediction distributions by a neural process and second training processing 132 of causing NP model 12 to perform feature representation learning using contrastive supervised learning.

### [2.1 Processing Procedure for Training Device 1]

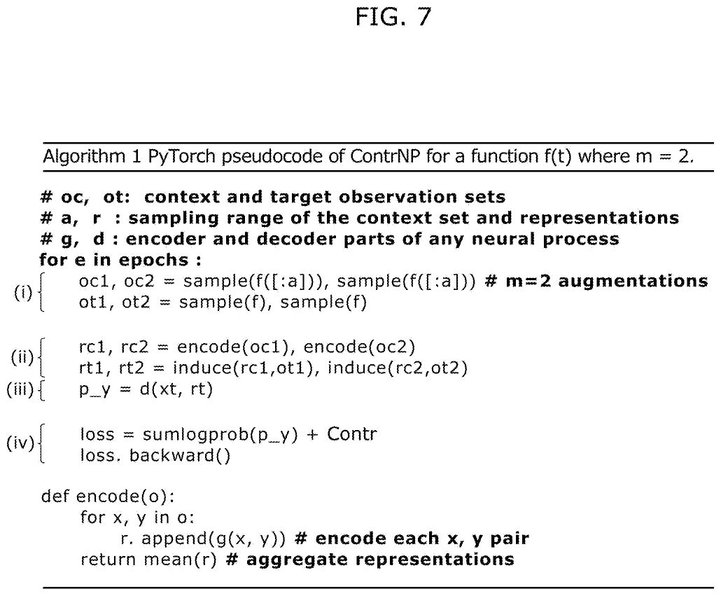

Subsequently, a processing procedure for training device 1 will be described with reference to FIG. 7.

FIG. 7 is a diagram illustrating a pseudocode of algorithm 1, which is a processing procedure for training device 1 according to the present embodiment. Algorithm 1 shown in FIG. 7 corresponds to the processing by training device 1 illustrated in FIG. 3 and is executed by, for example, a processor of training device 1. Note that functions shown in FIG. 7 such as f([:a]) and f denote the sets of original data illustrated in FIG. 3 (or sets of original time-series analog data), and f([:a]) and f indicate that they are different sets of original data.
(i) of FIG. 7 defines performing processing of obtaining two data items oc1 and oc2 by sampling an original time-series analog data or original data f([:a]). (i) of FIG. 7 also defines performing processing of obtaining two data items ot1 and ot2 by sampling an original time-series analog data or original data f. Note that processing in (i) of FIG. 7 corresponds to, for example, the processing of obtaining, from each of the sets of original data illustrated in the upper and lower rows in (a) of FIG. 3, two sample points (data items) by sampling as illustrated in the upper and lower rows in (b) of FIG. 3.
(ii) of FIG. 7 defines performing processing of obtaining, from two data items oc1 and oc2 obtained in the processing in (i) of FIG. 7, feature representations rc1 and rc2 in the latent space by extraction and aggregation using an encoder. (ii) of FIG. 7 also defines performing processing of deriving, from two data items ot1 and ot2 obtained in the processing in (i) of FIG. 7 and feature representations rd1 and rc2 in the latent space, feature representations rt1 and rt2 in the latent space. Note that processing in (ii) of FIG. 7 corresponds to, for example, the processing illustrated in the upper and lower rows in (b) of FIG. 3.
(iii) of FIG. 7 defines performing processing of obtaining prediction distributions p_y using a decoder from rt derived by the processing in (ii) of FIG. 7 and input data xt. That is, the processing in (iii) of FIG. 7 corresponds to, for example, the processing of outputting the prediction distributions illustrated in the upper and lower rows in (d) of FIG. 3.
(iv) of FIG. 7 defines performing processing of learning by error back propagation using the error function including the regression term and the contrastive term. That is, the processing in (iv) of FIG. 7 corresponds to, for example, second training processing 132 of performing contrastive learning on the feature representations in the latent space illustrated in the upper and lower rows in (c) of FIG. 3 and the processing of comparing the prediction distributions illustrated in the upper and lower rows in (d) of FIG. 3 with the theoretical values and reducing the errors.

Executing algorithm 1 defined in this manner, training device 1 can concurrently perform first training processing 131 of causing NP model 12 to learn the prediction distributions by a neural process and second training processing 132 of causing NP model 12 to perform feature representation learning using contrastive supervised learning.

### [2.2 Operation of Training Device 1]

Next, operation of training device 1 configured in the above-described manner will be described.

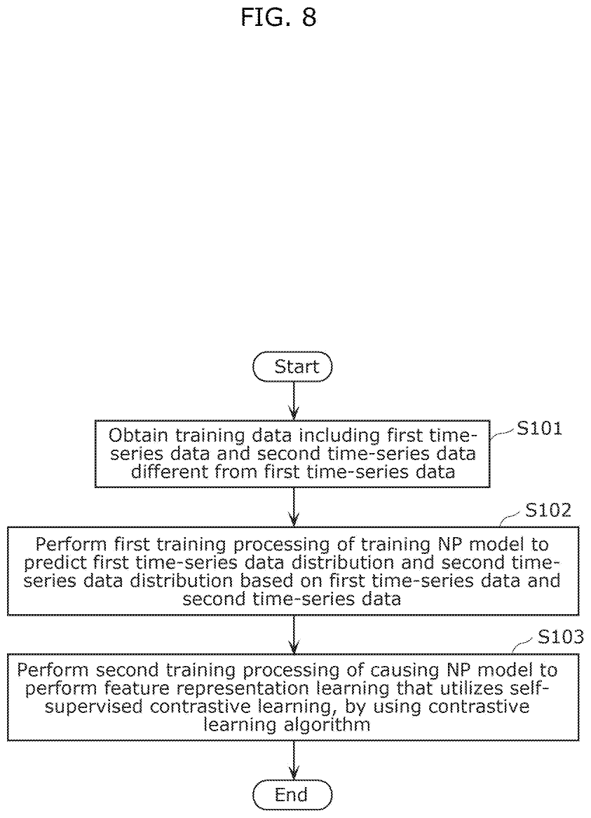

FIG. 8 is a flowchart illustrating an outline of the operation of training device 1 according to the present embodiment.

First, training device 1 obtains training data including first time-series data and second time-series data different from the first time-series data (S101).

Next, training device 1 performs first training processing of training NP model 12 to predict, based on the first time-series data and the second time-series data, a first time-series data distribution indicating a statistical characteristic of the first time-series data and a second time-series data distribution indicating a statistical characteristic of the second time-series data (S102).

Next, training device 1 performs, using a contrastive learning algorithm, second training processing of causing NP model 12 to perform feature representation learning using contrastive supervised learning (S103). Specifically, as second training processing 132, training processor 13 trains NP model 12 to bring first sampling data items close to each other as positive samples. Here, the first sampling data items are data items generated by sampling from the first time-series data distribution. Also, as second training processing 132 training processor 13 trains NP model 12 to bring second sampling data items close to each other as positive samples. Here, the second sampling data items are data items generated by sampling from the second time-series data distribution. On the other hand, as second training processing 132, training processor 13 trains NP model 12 to push away the first sampling data items and the second sampling data items far from each other as negative samples.

### [3 Advantageous Effects etc.]

As described above, according to training device 1 and the training method according to the present embodiment, a training method and the like capable of handling time-series data in self-supervised learning can be implemented by combining a framework of contrastive self-supervised learning and a framework of training a neural process model.

More specifically, according to training device 1 and the training method according to the present embodiment, using a neural process instead of data augmentation processing enables a neural process model to be trained (the first training processing) in such a manner that different data items are generated from the same original data in time-series data. Furthermore, the neural process model can be trained (the second training processing) by performing contrastive learning on feature representations in the latent space of two data items generated by the neural process. Therefore, according to training device 1 and the training method according to the present embodiment, the learning of time-series data taking uncertainty into account within a framework of a neural process and the learning of consistency of data using a framework of contrastive self-supervised learning can be performed by performing the first training processing and the second training processing. Accordingly, it becomes possible not only to implement a training method and the like capable of handling time-series data in self-supervised learning but also to perform learning to provide a high-accuracy model from a small amount of time-series data and a small number of labels for the small amount of time-series data.

Further, according to training device 1 and the training method according to the present embodiment, the first training processing and the second training processing are performed using an error function that is a combination of the first error function used in the contrastive learning algorithm and the second error function pertaining to the error of the prediction result used by the neural process model. With this, it is possible to concurrently perform, on a neural process model which is a training target, the first training processing of causing the neural process model to learn the prediction distributions by a neural process and the second training processing of causing the neural process model to perform feature representation learning using contrastive self-supervised learning.

### Experimental Example

Advantageous effects of the training method and the like according to the present disclosure were examined with datasets including MIT-BIH Atrial Fibrillation (AFDB), IMS Bearing, and Urban8K. Results of the examination will be described as an experimental example.

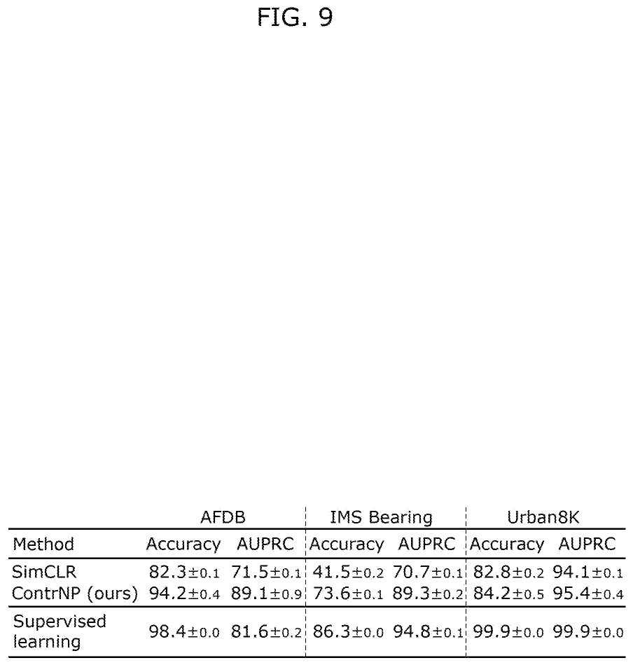

FIG. 9 is a diagram showing results of evaluating performance of the model according to the present disclosure using the datasets according to the experimental example. ContrNP (ours) shown in FIG. 9 corresponds to the model according to the present disclosure, that is, NP model 12 described above. FIG. 9 also shows, as comparative examples, results of evaluating performance of SimCLR and performance of supervised learning.

The AFDB dataset includes 25 electrocardiogram (ECG) data recordings. Each data item has a duration of approximately 10 hours. The AFDB dataset includes 4 classes: Atrial fibrillation, Atrial flutter, AV junctional rhythm, and: all other rhythms. Note that the AFDB dataset was chosen in the present experimental example because of a long duration of its data items and changing properties as time progresses (alternating classes).

The IMS Bearing dataset includes data recordings collected from run-to-failure experiments of dealing with four broken bearings that rotate at 2000 rpm on a shaft under a load of 6000 lbs. The IMS Bearing dataset is divided into 5 classes, each of which indicates a state of health (Early, Normal, Imminent failure, etc.) of the bearings.

Note that the IMS Bearing dataset was chosen in the present experimental example for evaluating performance on long, noisy industrial time-series data.

The Urban 8K dataset includes 8732 sound files of various lengths equal to or shorter than 4 seconds. The Urban 8K dataset is constituted by sound files divided into 10 classes including children_playing, car_horn, dog_bark, street_music, and the like.

Note that encoder 121 used in the present experimental example is constituted by a CNN. As shown in FIG. 9, the performance was evaluated by comparing accuracies (accuracy) and average precisions (AUPRC: area under the precision-recall curve). Values of the accuracies and the average precisions indicate averages of performing 5 times, 5 times, and 10 times.

As shown in FIG. 9, it is understood that, for example, on the AFDB dataset, the performance of ContrNP (ours), which is the model according to the present disclosure, exceeds performance of SimCLR, which is a comparative example, by 10% or greater.

From the above, it is understood that ContrNP (ours) being the model according to the present disclosure exceeds, in performance, SimCLR being a model in a comparative example on all the datasets although having an error function for contrastive learning that is similar to that of SimCLR being the comparative example. It is also understood that the performance of ContrNP (ours) being the model according to the present disclosure is not as good as the performance of supervised learning but is at a level close to that of the performance of supervised learning.

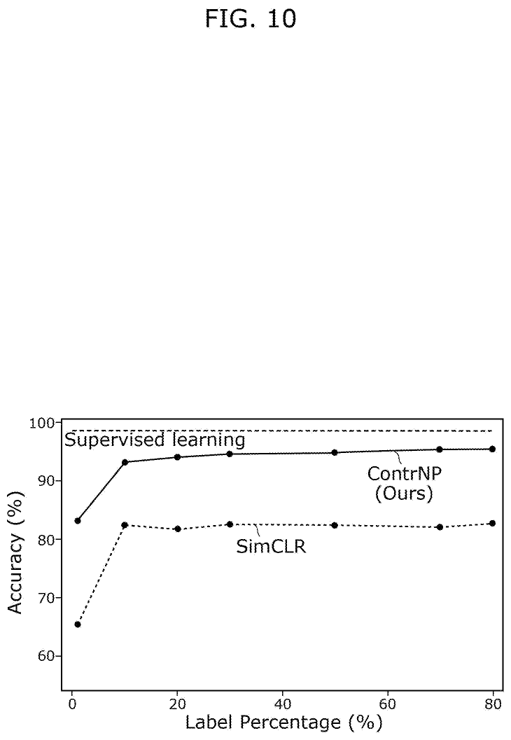

FIG. 10 is a graph illustrating accuracies when ContrNP (ours) was trained with different label percentages of the AFDB dataset according to the experimental example. FIG. 10 illustrates accuracies when SimCLR was trained as a comparative example and accuracies when supervised learning was performed.

As seen from FIG. 10, it is understood that ContrNP (ours), that is, the model according to the present disclosure shows an accuracy of 80% or greater even at a label percentage as low as a few percent, exceeding SimCLR in performance. Furthermore, it is understood that the model according to the present disclosure has a performance that provides accuracies close to those by supervised learning when a label percentage is about 15% or greater.

### Other Possible Embodiments

The training device and the training method according to the present disclosure are described above in the embodiment. An entity or a device that implements the types of processing is not limited to a particular entity or device. The processing may be performed by a processor or the like that is built in a specific device disposed locally. Alternatively, the processing may be performed by a cloud server or the like that is disposed in a place different from that of a local device.

Note that the present disclosure is not limited to the embodiment described above. For example, other embodiments achieved by any combination of the constituent elements described in this Specification and embodiments achieved by excluding some of the constituent elements may be considered as the embodiments of the present disclosure. Furthermore, variations achieved through various modifications to the above embodiment that can be conceived by a person of ordinary skill in the art without departing from the essence of the present disclosure, that is, the meaning of the wording in the claims, are also included in the present disclosure.

Moreover, the present disclosure further includes the following cases.
(1) The devices described above are specifically computer systems each including a microprocessor, ROM, random-access memory (RAM), a hard disk unit, a display unit, a keyboard, a mouse, etc. The RAM or hard disk unit stores a computer program. Each device fulfils its function as a result of the microprocessor operating according to the computer program. Here, the computer program is configured of a plurality of pieced together instruction codes indicating instructions to the computer for fulfilling predetermined functions.
(2) Some or all of the constituent elements included in the devices described above may be configured as a single system large scale integration (LSI) circuit. A system LSI is a super multifunctional LSI manufactured by integrating a plurality of units on a single chip, and is specifically a computer system including, for example, a microprocessor, ROM, and RAM. A computer program is stored in the RAM. The system LSI circuit fulfills its function as a result of the microprocessor operating according to the computer program.
(3) Some or all of the constituent elements included in the devices described above may be configured as an integrated circuit (IC) card or standalone module attachable to and detachable from each device. The IC card or module is a computer system including, for example, a microprocessor, ROM, and RAM. The IC card or module may include the super multifunctional LSI described above. The IC card or module fulfills its function as a result of the microprocessor operating according to a computer program. The IC card or module may be tamperproof.
(4) The present disclosure may be the method described above. The present disclosure may be a computer program realizing these methods with a computer, or a digital signal of the computer program.
(5) The present disclosure may be a computer-readable recording medium, such as a flexible disk, a hard disk, a CD-ROM, an MO, a DVD, a DVD-ROM, DVD-RAM, a Blu-ray (registered trademark) Disc (BD), and semiconductor memory having recording thereon the computer program or the digital signal. The present disclosure may also be the digital signal recorded on these recording media.

The present disclosure may transmit the computer program or the digital signal via, for example, a telecommunication line, a wireless or wired communication line, a network such as the Internet, or data broadcasting.

The present disclosure may be a computer system including a microprocessor and memory. The memory may store the computer program, and the microprocessor may operate according to the computer program.

The present disclosure may be implemented by another independent computer system by recording the program or the digital signal on the recording medium and transporting it, or by transporting the program or the digital signal via the network, etc.

### Industrial Applicability

The present disclosure is applicable to a training method, a training device, and a program that trains a high-accuracy model from a small amount of data and a small number of labels, particularly to a training method, a training device, and a program capable of training a high-accuracy model that handles time-series data, by self-supervised learning.

1. A training method performed through batch learning by a computer, the training method comprising:
obtaining training data including first time-series data and second time-series data different from the first time-series data;
performing first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account; and
performing, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

2. The training method according to claim 1,
wherein the first time-series data is time-series sampling data obtained by sampling temporally-continuous first data, and
the second time-series data is time-series sampling data obtained by sampling temporally-continuous second data.

3. The training method according to claim 1,
wherein the first training processing and the second training processing are performed concurrently, and
the performing of the first training processing and the second training processing includes
using an error function in which a second error function is changed by adding a term of a first error function used in the contrastive learning algorithm to a term of the second error function, the first error function reducing an error in a case of the positive samples and increasing the error in a case of the negative samples, the second error function pertaining to an error of a prediction result used by the neural process model.

4. A training device that performs training through batch learning, the training device comprising:
an obtainer that obtains training data including first time-series data and second time-series data different from the first time-series data; and
a training processor that
performs first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account, and
performs, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.

5. A non-transitory computer-readable recording medium having recorded thereon a program for causing a computer to execute a training method through batch learning, the program causing the computer to execute:
obtaining training data including first time-series data and second time-series data different from the first time-series data;
performing first training processing of training a neural process model to predict, based on the first time-series data and the second time-series data, a first time-series data distribution indicating a statistical characteristic of the first time-series data and a second time-series data distribution indicating a statistical characteristic of the second time-series data, the neural process model being a deep learning model that outputs, using a stochastic process, a prediction result that takes uncertainty into account; and
performing, using a contrastive learning algorithm, second training processing of (i) training the neural process model to bring first sampling data items close to each other as positive samples, the first sampling data items being generated by sampling from the first time-series data distribution, (ii) training the neural process model to bring second sampling data items close to each other as positive samples, the second sampling data items being generated by sampling from the second time-series data distribution, and (iii) training the neural process model to push away the first sampling data items and the second sampling data items far from each other as negative samples.
